(19) United States
(12) Patent Application Publication
(10) Pub. No.: US 2022/0197706 A1
(43) Pub. Date: Jun. 23, 2022

(54) SCHEDULING OF A CYBER-PHYSICAL SYSTEM PROCESS THROUGH A UTILITY FUNCTION

(71) Applicant: Hewlett-Packard Development Company, L.P., Spring, TX (US)

(72) Inventors: Jonathan Munir Salfity, Palo Alto, CA (US); Amalendu Kulthumani Iyer, Palo Alto, CA (US); Christian Makaya, Palo Alto, CA (US)

(73) Assignee: Hewlett-Packard Development Company, L.P., Spring, TX (US)

(21) Appl. No.: 17/418,797

(22) PCT Filed: Sep. 11, 2019
(86) PCT No.: PCT/US2019/050572

§ 371 Date: Jun. 26, 2021

(51) Int. Cl. G06F 9/50; G06F 9/48

(52) U.S. Cl. CPC G06F 9/5044; G06F 2209/501; G06F 9/4881; G06F 9/5055

(57) ABSTRACT

Examples of scheduling of a cyber-physical system (CPS) process through a utility function are described. In an example, a plurality of computing resources to perform a process for the CPS may be evaluated based on a utility function. A first computing resource may be onboard the CPS and a second computing resource may be a remote computing resource. A computing resource that optimizes the utility function may be scheduled to perform the process for the CPS.

### BACKGROUND

A cyber-physical system (CPS) is a computing device that interacts with a physical environment. For example, a CPS may include sensors to detect its surroundings. The CPS may also include mechanisms to interact with its surroundings based on the sensor measurements. In some examples, a CPS may communicate with other computing resources in a network environment.

### BRIEF DESCRIPTION OF THE DRAWINGS

Various examples will be described below by referring to the following figures.

FIG. 1 is a block diagram of an example of a scheduler device to schedule a cyber-physical system (CPS) process through a utility function;

FIG. 2 is a flow diagram illustrating an example of a method for scheduling of a CPS process through a utility function;

FIG. 3 is a flow diagram illustrating another example of a method for scheduling of a CPS process through a utility function; and

FIG. 4 is a block diagram illustrating an example of a network of computing resources to perform a process for a CPS.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

The techniques described herein relate to scheduling of a cyber-physical system (CPS) process through a utility function. As used herein a cyber-physical system (CPS) is a sensing and actuation device that interfaces with its physical environment. A CPS may communicate with other devices through a network. Some examples of a CPS include internet-of-things (IoT) devices, autonomous vehicle systems, robotic devices (e.g., manufacturing, robotic surgery, search and rescue, firefighting), building automation, and human physical-augmentation devices.

In some examples, a CPS may be a mobile system. For example, the CPS may be a battery-powered robot. In other examples, the CPS may be a battery-powered device that is transported by another entity (e.g., human). In some examples, a smartphone may be a CPS having sensor inputs (e.g., touchscreen, microphones, GPS, cellular modem, etc.) and outputs (e.g., speakers, display, lights, etc.).

In other examples, the CPS may be a stationary system. In this case, the CPS may be connected to an external power source (e.g., electricity line).

Computing approaches have evolved at a fast pace, from high-powered servers to small devices. With the increasing adoption of cyber-physical systems, distributed computing has enabled the spread of computing capabilities across a network of devices installed on-premises, in data centers, or in the cloud (e.g., in an internet-based distributed network). Furthermore, the use of edge computing allows for processing of data generated by the physical environment and computing systems closer to the data source. In edge computing, data storage and computing are brought closer to the physical location where it is used. In some examples, a CPS may be combined with advanced analytics, machine learning, and edge computing to allow and improve data-driven decision making. It should be noted that the CPS may be a physical environment sensing device and/or an actuator, but the data location may or may not be a physical location. For example, in some cases, the data location for the CPS may be a virtualized location.

A CPS is a sensing and actuation device with connectivity to a network while interfacing the physical environment. With the adoption of automation in various industries and environments, CPS faces different design choices. Each of the processes controlling the functionality of a CPS may be characterized by various constraints and factors, depending on the use cases. As used herein, a “process” for a CPS is a discrete job, task and/or workload to be performed for the CPS. Factors that impact a process for a CPS may include maximum latency allowed, the cost to move information between the CPS and other network resources, energy resources, stability of the CPS and reliability of the CPS.

The processes for a CPS are constrained by various choices. For example, these choices may include how to manage motor control operation, how to prioritize a given process from another, etc. With limited computing capabilities, how to offload some tasks to external computing nodes (referred to herein as a remote computing resource) is another challenge faced by a CPS. Because the functionality and operation of the CPS are very complex, they can be defined as a dynamic optimization procedure. In this case, a scheduler may select which computing resource (e.g., virtual or physical) is to run a given process based on the use case supported.

In some examples, a CPS (e.g., robot) may repeat a “sense, think/process, and act” loop for closed-loop control processes during autonomous operation. Closed-loop control processes can range from controlling low-level motor voltage given a reference velocity to controlling high-level robot behaviors given surrounding human emotions or physical behaviors detected. While loops may run at different frequencies and/or may move larger or smaller quantities of information, the dynamic scheduler described herein may select which computing resource location to execute the think/act portion of the control-loop system.

Examples are described that allow for an efficient selection of computing resources to run each process, such as closed-loop control, based on the requirements of the processes (e.g., tasks) assigned to the CPS. A utility function is defined to capture the reward intended to be optimized by the CPS and perform given processes to achieve certain goals.

Due to improvements in connectivity, cyber-physical systems may not contain all their computing resources onboard. As used herein, a computing resource may include a processor to execute instructions stored in memory. In some examples, a modular approach may be used to design a CPS, enabling its usage in different scenarios.

To improve usability, different functionalities in the CPS may operate independently while trying to achieve a common defined goal. Because a CPS is a device composed of several components that interact with the physical environment, some of the workload and processes of the CPS may be offloaded to external entities (e.g., remote computing resources) to achieve higher performance. Furthermore, cost-effectiveness and energy efficiency may be optimized by distributing the processes across different entities and computing nodes.

The approaches described herein allow a CPS to utilize edge computing, distributed on-premises computing, and off-premises (e.g., cloud) computing. With this ability, the CPS may have more processing capability and/or more processing power, which eventually gives rise to more applications for the CPS. However, this also means that the CPS developers may pay close attention to where and how these workloads are located. In other words, the design of a CPS may consider the fact that processes of its operations can be executed on other computing resources. Instead of manually allocating processes, a scheduler may use a utility function that when optimized leads to an optimal partitioning of workloads.

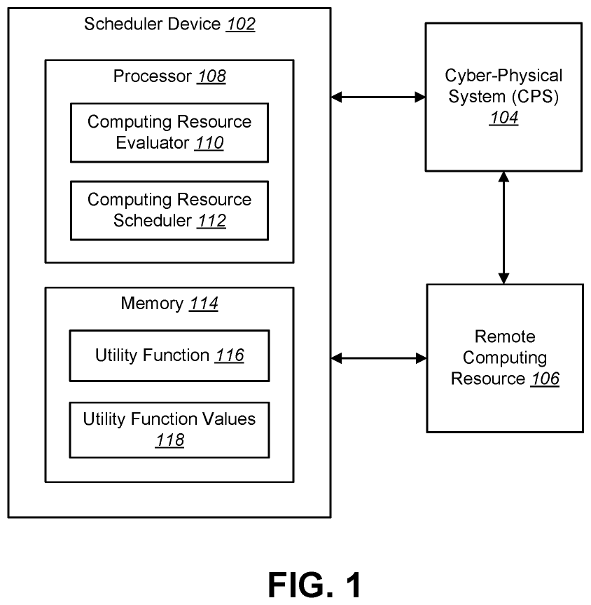

FIG. 1 is a block diagram of an example of a scheduler device 102 to schedule a cyber-physical system (CPS) 104 process through a utility function 116. The CPS 104 may be a computing device that interacts with its environment. The CPS 104 may include a sensor or multiple sensors to detect changes in its environment. The CPS 104 may also include an actuation mechanism or multiple actuation mechanisms to interact with the environment.

The CPS 104 may further include a computing resource to process sensor data and control the actuation mechanism. In some examples, the computing resource may include a processor and memory. For instance, the memory may store sensor data. The processor may process the sensor data to determine how to control the actuation mechanism. Some examples of a CPS 104 include a robotic device, an internet-of-things (IoT) device, an autonomous vehicle system, a building automation device, and/or human physical-augmentation device.

In some examples, the CPS 104 may be a battery-powered device. For example, the CPS 104 may be a mobile device that is powered by a battery. In other examples, the CPS 104 may be a line-powered device. For example, the CPS 104 may be powered by an electrical line. In this case, the mobility of the CPS 104 may be limited. For example, in the case of a line-powered device, the CPS 104 may be stationary or limited to short distances of mobility permitted by the electrical wire powering the CPS 104.

The CPS 104 may communicate with other devices in a network. For example, the CPS 104 may communicate with a scheduler device 102 and/or a remote computing resource 106 in a computing network. In some examples, the CPS 104 may communicate with other computing devices over a local area network (LAN) using a wired connection (e.g., Ethernet) or wireless connection (e.g., WiFi, ZigBee, Bluetooth, cellular, etc.). In other examples, the CPS 104 may communicate with computing devices outside a LAN using the internet. These remote computing resources 106 may be referred to as cloud devices or cloud resources.

In some examples, the scheduler device 102 may determine the location of a computing resource to perform a process for the CPS 104. In the example illustrated in FIG. 1, the scheduler device 102 is a computing device in communication with the CPS 104. In this case, the scheduler device 102 may be located on the same LAN as the CPS 104, or may communicate across a remote network (e.g., the internet). In other examples, the scheduler device 102 may be implemented as part of the CPS 104. In yet other examples, the scheduler device 102 may be a virtual device implemented by a number of different computing devices.

In this example, the scheduler device 102 may be a server computer, a personal computer, a smartphone, a tablet computer, cloud service, etc. The scheduler device 102 may include and/or may be coupled to a processor 108 and/or a memory 114. In some examples, the scheduler device 102 may include a display and/or an input/output interface. In some examples, the scheduler device 102 may be in communication with (e.g., coupled to, have a communication link with) an external device (e.g., the CPS 104 and/or a remote computing resource 106). The scheduler device 102 may include additional components (not shown) and/or some of the components described herein may be removed and/or modified without departing from the scope of this disclosure.

The processor 108 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 114. The processor 108 may fetch, decode, and/or execute instructions (e.g., the utility function 116) stored in the memory 114. In some examples, the processor 108 may include an electronic circuit or circuits that include electronic components for performing a function or functions of the instructions (e.g., the utility function 116). In some examples, the processor 108 may perform one, some, or all of the functions, operations, elements, methods, etc., described in connection with one, some, or all of FIGS. 1-4.

The memory 114 may be any electronic, magnetic, optical, or other physical storage device that contains or stores electronic information (e.g., instructions and/or data). The memory 114 may be, for example, Random Access Memory (RAM), Electrically Erasable Programmable Read-Only Memory (EEPROM), a storage device, an optical disc, and the like. In some examples, the memory 114 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 114 may be a non-transitory tangible machine-readable storage medium, where the term “non-transitory” does not encompass transitory propagating signals. In some examples, the memory 114 may include multiple devices (e.g., a RAM card and a solid-state drive (SSD)).

In some examples, the scheduler device 102 may include an input/output interface through which the processor 108 may communicate with an external device or devices (not shown), for instance, to receive and store information (e.g., utility function factors). The input/output interface may include hardware and/or machine-readable instructions to enable the processor 108 to communicate with the external device or devices. The input/output interface may enable a wired or wireless connection to the external device or devices (e.g., the CPS 104 and/or a remote computing resource 106, etc.). The input/output interface may further include a network interface card and/or may also include hardware and/or machine-readable instructions to enable the processor 108 to communicate with various input and/or output devices, such as a keyboard, a mouse, a display, a touchscreen, a microphone, a controller, another apparatus, electronic device, computing device, etc., through which a user may input instructions into the scheduler device 102.

In some examples, the processor 108 may include a computing resource evaluator 110. The computing resource evaluator 110 may evaluate a plurality of computing resources to perform a process for the CPS 104 based on a utility function 116. A first computing resource may be onboard the CPS 104. For example, the first computing resource may be a processor and memory of the CPS 104. In other words, the first computing resource may be the local computing resources of the CPS 104.

A second computing resource may be a remote compute resource 106. In some examples, the remote computing resource 106 may be an edge computing device. In this case, the remote computing resource 106 may be a computing device that is physically located near the CPS 104. For example, the remote computing resource 106 may be on the same LAN as the CPS 104. In other examples, the remote computing resource 106 may be a cloud computing device. In this case, the scheduler device 102 may communicate with the remote computing resource 106 over the internet.

In some examples, the computing resource evaluator 110 may evaluate a plurality of remote computing resources 106. For example, a first remote computing resource 106 may be on the same LAN as the CPS 104 and a second remote computing resource 106 may be a cloud resource.

The computing resource evaluator 110 may evaluate the plurality of computing resources (e.g., the CPS 104 and the remote computing resource(s) 106) by calculating a utility function value 118 for each of a plurality of computing resources. The utility function 116 may capture significant aspects of distributed computing for the CPS 104. The scheduler device 102 may use the utility function 116 to decide where to schedule processes for the CPS 104.

In some examples, the utility function 116 weights a plurality of factors to perform the process. The plurality of factors may include latency, cost, energy consumption and CPS stability to perform the process jobs.

The latency evaluated by the utility function 116 may include a time for the process to be executed on a computing resource and for the results to be available for the CPS 104. In other words, latency may be the time for the process workload to be executed on a compute node (on which the process is being offloaded) and the time for the results to become available for the CPS 104. For example, the latency for the CPS 104 to implement a process locally may be less than the latency for the process to be performed on an edge computing resource (e.g., a workstation located on the same LAN as the CPS 104). However, the edge computing resource may have less latency than a cloud computing resource, which may have a high latency. In an example, the computing resource evaluator 110 may measure or estimate the latency that would occur to perform the process on a given computing resource. This latency value may be applied to the utility function 116, which may weight the latency value.

In some examples, the latency evaluated by the utility function 116 may depend on the difficulty of a workload. For example, a workload that entails significant processing may be faster on a cloud computer because the processing power would outweigh the time for transmission. In contrast, the transmission latency may dominate for an easy workload. Therefore, in evaluating latency, the computing resource evaluator 110 may determine workload difficulty.

In some examples, the cost evaluated by the utility function 116 may include a computed amount to be paid to a provider of a computing resource to perform the process on the computing resource. In other words, the cost may be an amount paid to the provider of the compute node running the process. The cost may be negligible or nonexistent if the process is run on the CPS 104 or a remote computing resource 106 that is owned by the same organization that owns the CPS 104. However, costs may be incurred if the process is run on a cloud service or virtual instances in the cloud. In an example, the computing resource evaluator 110 may measure or estimate the cost incurred to perform the process on a given computing resource. This cost value may be applied to the utility function 116, which may weight the cost value.

The energy consumption (also referred to as power consumption) evaluated by the utility function 116 may include an estimated or measured amount of energy (e.g., electricity) to perform the process on the computing resource. For example, the utility function 116 may evaluate the energy consumed by a local computing resource running the process on the CPS 104. The utility function 116 may also evaluate the energy consumed on the remote computing resource(s) 106. The energy consumption factor may be weighted higher for a computing resource (e.g., the CPS 104 or remote computing resource(s) 106) that is battery powered or otherwise energy-limited (e.g., solar powered). In an example, the computing resource evaluator 110 may measure or estimate the amount of energy (e.g., electricity) used to perform the process on a given computing resource. This value may be applied to the utility function 116, which may weight the energy consumption value.

The CPS stability factor evaluated by the utility function 116 may include maintaining the CPS at an equilibrium point. CPS stability may be how far away the CPS 104 is from an equilibrium point or set point, which is based on the system dynamics. Stability can be calculated by how far away the system is from an equilibrium point or desired set point or the rate of departure from an equilibrium point. Upon deployment, some cyber-physical systems are inherently stable (e.g., a wheeled robot), while some cyber-physical systems are inherently unstable (e.g., a walking robot). Control systems may be designed to counteract instability, reject disturbances and provide inputs to drive the system to desired states. During initialization and while in operation, the CPS stability factor of the utility function 116 may gauge system stability and schedule computing resources for actions to drive the system toward stable configurations. Other aspects of CPS stability that may be included in this factor include fault tolerance, performance of the CPS 104, accuracy of the CPS 104 and/or availability of the CPS 104.

In an example, the computing resource evaluator 110 may calculate the CPS stability associated with performing the process on a given computing resource. For instance, the computing resource evaluator 110 may calculate how far away the CPS 104 will be from an equilibrium point or desired set point or the rate of departure from an equilibrium point if the process is performed by a given computing resource. This CPS stability value may be applied to the utility function 116, which may weight the CPS stability value.

It should be noted that the factors (i.e., variables) used in the utility function 116 may include other factors than those listed above. For example, the factors used by the utility function 116 may be any factor defined by the system designer. This may include factors in addition to, or different than, latency, cost, energy consumption and CPS stability. Therefore, the above described variables (e.g., latency, cost, energy consumption and CPS stability) used in the utility function 116 are not exhaustive and other variables might be defined by the system designer.

In some examples, the utility function 116 may include constraints, conditions and/or requirements for the factors. For example, the utility function 116 may indicate that the cost may not be above a given threshold. In another example, the utility function 116 may indicate that the latency may not be above a certain threshold, etc.

The utility function 116 may represent the significance of each factor by assigning weights and relative weights to each factor. For example, if a CPS 104 has a large power supply, the energy consumption factor may be weighted low. In other words, energy efficiency may not be a concern when determining the computing resource to perform the process. In another example, if the CPS 104 is inherently unstable or has the ability to drift to unstable configurations, more weight may be given to the CPS stability weighting. Hence, the weights of the utility function 116 may be defined based on the capabilities of the CPS 404 and the use case of the process.

In some examples, the utility function 116 may by calculated upon initialization of the CPS 104. The utility function 116 may be updated during deployment of the CPS 104. For example, if an extra battery or extra motor is added to the CPS 104 during deployment, the utility function 116 (e.g., the weights of the utility function factors) may be updated to reflect the change in the CPS 104.

In some examples, the utility function 116 may be expressed as a sum of weights and inputs. An example of the utility function 116 is illustrated in Equation (1).

Utility (l, c, e, s)=\vec{w}·[f₁(l), f₂(c), f₃(e), f₄(s)]^{T} (1)

In Equation (1), \vec{w} is the weights assigned by the system designer, l is the latency, c is the cost, e is energy consumption and s is the CPS stability. In Equation (1), f₁₋₄ are mathematical functions associated with each factor.

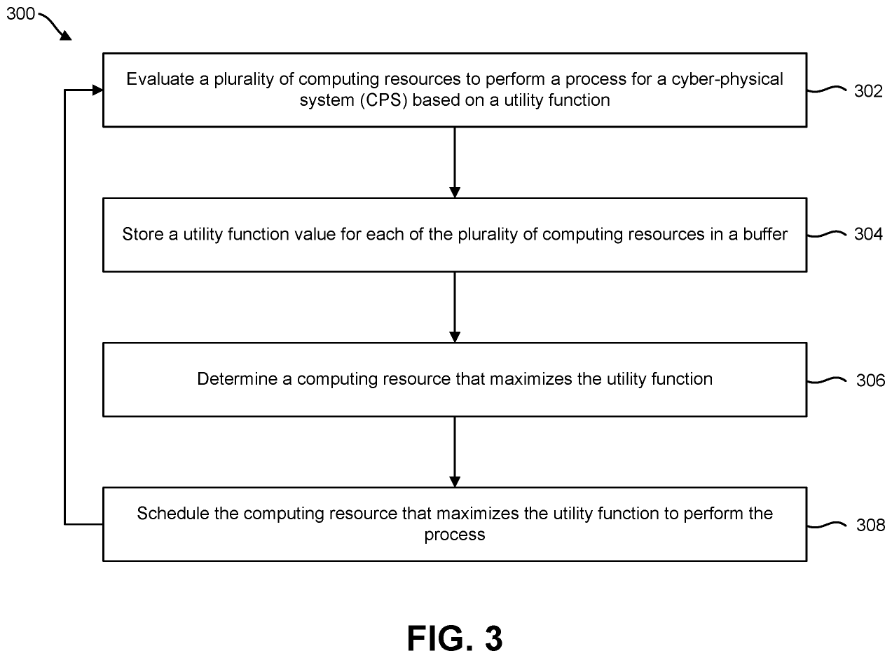

The processor 108 may also include a computing resource scheduler 112. The computing resource scheduler 112 may schedule a computing resource that optimizes the utility function 116 to perform the process for the CPS 104. Equation (1) is an example of a mathematical formalization of the utility function 116. In some examples, to maximize (e.g., optimize) the utility function 116 an iterative process can be used such as that illustrated in FIG. 3. The computing resource scheduler 112 may allocate the computing resource(s) that maximizes the utility function to perform the process.

Before executing this procedure, the action space may be initialized with the set of possible placements of the processes that are to be distributed across different computing resources. The system designer may assign weights (e.g., latency, cost, energy consumption and CPS stability) to the utility function 116. For example, in scenarios where reducing latency is of higher significance than cost, the weight for latency may be higher than that of cost. In other examples, in scenarios where CPS stability is more significant than reducing energy consumption, the weight for CPS stability may be higher than energy consumption.

After initialization, a process may be selected and the workloads may be distributed accordingly. The outcome of this action may be captured as a utility function value 118 in terms of latency, cost, energy consumption and CPS stability for each of the plurality of computing resources. The calculated utility function values 118 may be used to evaluate the utility of the process. The calculated function values 118 may be stored in a buffer.

In an example, the computing resource evaluator 110 may calculate a utility function value 118 to perform the process by a computing resource onboard the CPS 104. The computing resource evaluator 110 may also calculate a utility function value 118 to perform the process by a remote computing resource 106. In the case of a plurality of remote computing resources 106, the computing resource evaluator 110 may calculate a utility function value 118 to perform the process for each of the plurality of remote computing resources 106.

The computing resource scheduler 112 may schedule a computing resource that maximizes the utility function 116 to perform the process. As used herein, maximizing the utility function 116 refers to determining an optimal utility function value 118. In one approach, the optimal utility function value 118 may be a utility function value 118 with the highest (e.g., maximum) value. In another approach, the optimal utility function value 118 may be the utility function value 118 with the lowest (e.g., minimum) value. In other words, the optimal utility function value 118 may be expressed as either a maximum value or minimum value.

In an example, if the process is weighted high for latency, then the process may perform best with a low amount of latency. An example of such a process includes motor control for the CPS 104. In this case, the utility function value 118 for the computing resource of the CPS 104 itself may be highest in that the CPS 104 provides the lowest latency for controlling its motors. In this case, the computing resource scheduler 112 may schedule the CPS 104 to perform the motor control process.

In another example, the process may be image processing. For instance, the CPS 104 may capture a number of images that may be used for image processing (e.g., object recognition). In this case, the CPS 104 may be battery powered. Therefore, energy consumption may be weighted high for an image processing process, which may be energy intense. Furthermore, the latency for the image processing may be weighted low (i.e., a certain amount of latency may be acceptable for the image processing). In this case, the utility function value 118 for an edge computing resource (e.g., workstation) or cloud resource may be higher than the CPS 104. The computing resource scheduler 112 may schedule the workstation or cloud resource to perform the image processing. This may help conserve energy on the battery-powered CPS 104.

In yet another example, for systems in which performance, accuracy and/or availability are significant, the CPS stability factor may be weighted high. In this case, the utility function value 118 for an edge computing resource (e.g., workstation or laptop) may yield optimal results. For instance, the edge computing resource may provide more computing power and energy than the CPS 104, and may provide less latency than a cloud resource. These characteristics may enhance the stability (e.g., performance, accuracy and/or availability) of the CPS 104.

In some examples, the scheduler device 102 may select a utility function 116 to evaluate the plurality of computing resources to perform a given process. For example, the scheduler device 102 may be configured with a number of utility functions 116, where a certain utility function 116 is associated with a given process. For example, a motor control process may be associated with one utility function 116 and an image processing process may be associated with another utility function 116. The different utility functions 116 may be assigned different weights for a plurality of factors (e.g., latency, cost, energy consumption and CPS stability) based on the capability of the CPS 104 and a use case of the process. Therefore, the scheduler device 102 may schedule a plurality of processes to be performed for the CPS 104 from among the plurality of computing resources based on a utility function 116 associated with each of the plurality of processes.

In some examples, the processes scheduled by the scheduler device 102 may have different frequencies. For example, some processes (e.g., sensor data storage, motor control, etc.) may have high frequencies (i.e., may occur frequently), while other processes (e.g., image processing, machine learning applications) may have low frequencies. The scheduler device 102 may evaluate the frequency of the processes through the utility function. For example, high-frequency processes may weight latency higher than low-frequency processes. Therefore, the utility function 116 may factor in the frequency of processes to be performed for the CPS 104. While loops may run at different frequencies and/or may move larger or smaller quantities of information, the scheduler device 102 may select which computing resource location to execute the think and act portion of the CPS 104.

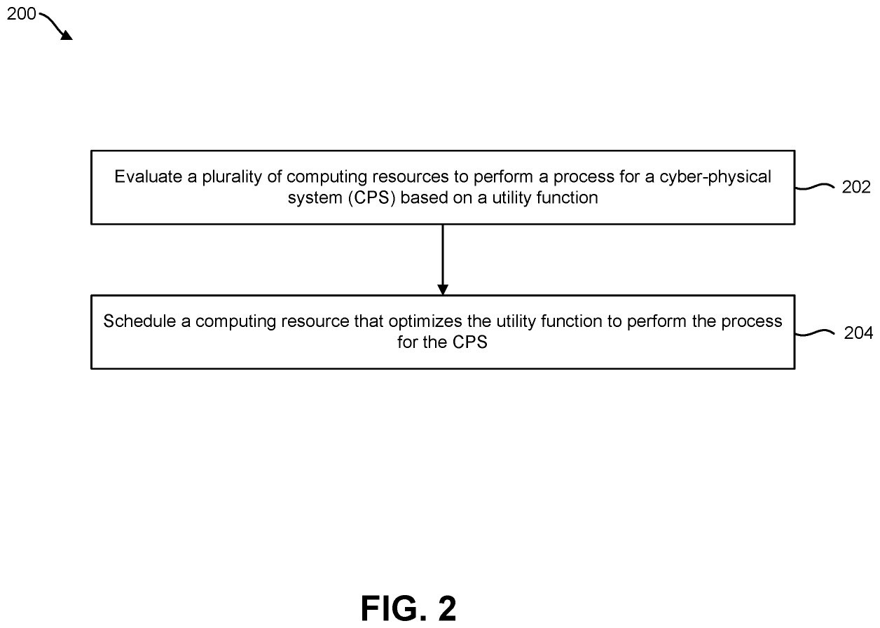

FIG. 2 is a flow diagram illustrating an example of a method 200 for scheduling of a cyber-physical system (CPS) 104 process through a utility function 116. The method 200 may be performed by, for example, the processor 108 of a scheduler device 102.

The processor 108 may evaluate 202 a plurality of computing resources to perform a process for the CPS 104 based on a utility function 116. In some examples, a first computing resource may be onboard the CPS 104. A second computing resource may be a remote computing resource 106. In yet other examples, the processor 108 may evaluate 202 a plurality of remote computing resources 106 to perform the process. A remote computing resource 106 may be an edge computing device. In other cases, the remote computing resource 106 may be a cloud computing resource.

In some examples, the processor 108 may determine the process to be performed for the CPS 104. For example, the process may be an action to be performed by the CPS 104 based on sensor data measured by the CPS 104. The process may be associated with a certain utility function 116. The processor 108 may select the utility function 116 that is associated with the process.

To evaluate 202 the plurality of computing resources, the processor 108 may calculate a utility function value 118 to perform the process by a computing resource onboard the CPS 104. The processor 108 may also calculate a utility function value 118 to perform the process by a remote computing resource 106. In the case of a plurality of remote computing resources 106, the processor 108 may calculate the utility function value 118 for each of a plurality of remote computing resources.

In some examples, the utility function 116 may weight a plurality of factors to perform the process. The plurality of factors of the utility function 116 may include latency, cost, energy consumption and CPS stability to perform the process.

The processor 108 may schedule 204 a computing resource that optimizes the utility function 116 to perform the process for the CPS 104. For example, the processor 108 may determine which computing resource has a utility function value 118 that maximizes the utility function 116. The processor 108 may select the computing resource that maximizes the utility function 116 to perform the process. For example, the processor 108 may schedule either the onboard computing resources of the CPS 104 or a remote computing resource 106 to perform the process based on the utility function value 118 that maximizes the utility function 116.

FIG. 3 is a flow diagram illustrating another example of a method 300 for scheduling of a CPS 104 process through a utility function 116. The method 300 may be performed by, for example, the processor 108 of a scheduler device 102.

The processor 108 may evaluate 302 a plurality of computing resources to perform a process for the CPS 104 based on a utility function 116. For example, the processor 108 may calculate a utility function value 118 for each of a plurality of computing resources to perform a process for the CPS 104. It should be noted that the processor 108 may determine a separate utility function value 118 for each computing resource being evaluated.

To calculate the utility function value 118 for a given computing resource, the processor 108 may evaluate a plurality of factors to perform the process. The plurality of factors of the utility function 116 may include latency, cost, energy consumption and CPS stability to perform the process by a given computing resource. The utility function 116 may weight the plurality of factors to perform the process. The weights may be assigned to each of the plurality of factors based on capability of the CPS 104 and a use case of the process. In some examples, the utility function values 118 may be determined according to Equation (1).

In an example, the processor 108 may calculate the latency to perform the process by each of the plurality of computing resources. In this case, the latency may be the time for the process to be executed on a computing resource and for the results to be available for the CPS 104.

In another example, the processor 108 may calculate the cost to perform the process on each of the plurality of computing resources. In this case, the cost may be the computed amount to be paid to a provider of a computing resource to perform the process on the computing resource. For example, if the process is performed on a cloud resource, the processor 108 may determine the cost to be paid to the cloud service provider.

In another example, the processor 108 may calculate the energy consumption to perform the process on each of the plurality of computing resources. In this case, the energy consumption may be an estimated amount of energy used to perform the process on the computing resource. In some examples, the processor 108 may calculate the energy consumption for energy-limited computing resources (e.g., battery-powered devices).

In yet another example, the processor 108 may calculate the CPS stability to perform the process on each of the plurality of computing resources. For example, the processor 108 may determine the degree to which a computing resource will maintain the CPS at an equilibrium point.

The processor 108 may store 304 the utility function value 118 for each of the plurality of computing resources in a buffer. For example, upon determining the utility function value 118 for a given computing resource (e.g., the CPS 104 or remote computing resource 106), the processor 108 may store the utility function value 118 in memory 114.

The processor 108 may determine 306 a computing resource that maximizes the utility function 116. For example, the processor 108 may determine which utility function value 118 has the greatest (e.g., maximum) value. The maximum utility function value 118 may maximize the utility function 116. It should be noted that in some cases, more than one computing resource may result in a maximum utility function value 118.

The processor 108 may schedule 308 the process on the computing resource that maximizes the utility function 116. For example, the processor 108 may select the computing resource (e.g., CPS 104, edge computing resource, cloud computing resource) with the maximum utility function value 118 to perform the process. The processor 108 may allocate the computing resource(s) that maximizes the utility function to perform the process. As described above, more than one computing resource may maximize the utility function value 118. In this case, the processor 108 may select one or multiple computing resources that maximize the utility function 116 to perform the process.

Upon scheduling 308 the process on a computing resource, the processor 108 may schedule a new process by evaluating 302 the plurality of computing resource to perform the new process. The new process may be scheduled on a computing resource based on the highest utility in the buffer. In some examples, the new process may be selected to balance currently performing processes.

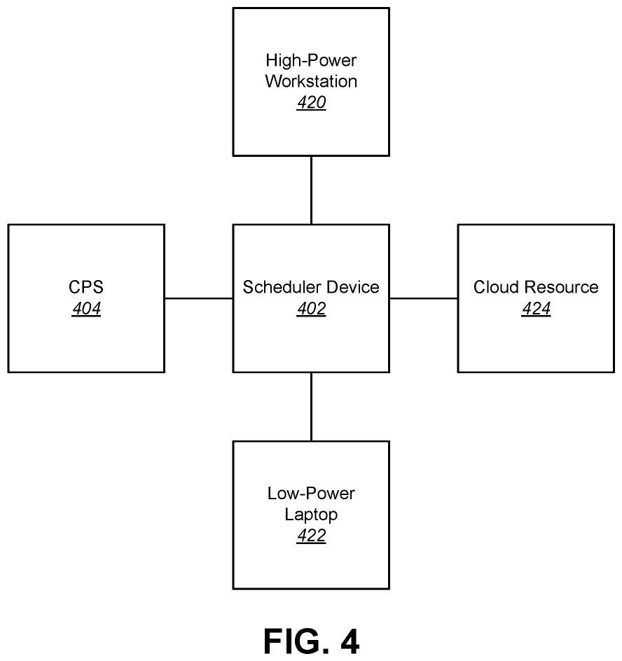

FIG. 4 is a block diagram illustrating an example of a network of computing resources to perform a process for a CPS 404. In this example, the CPS 404 may communicate with a scheduler device 402 in a network.

In this example, the CPS 404 has different computing resources available to process information. In some cases, the CPS 404 may use its onboard computing resources to perform a process.

In other cases, the process may be performed by a remote computing device. In this example, a high-power workstation 420 and a low-power laptop 422 may be available to perform the process for the CPS 404. The high-power workstation 420 may be connected to the electrical grid. The low-power laptop 422 may be battery powered. The CPS 404 may also communicate with a cloud resource 424.

The scheduler device 402 may schedule a computing resource to perform a process for the CPS 404. The scheduler device 402 may use a weighted utility function 116 to select where to process each job. In this example, the scheduler device 402 may schedule light, fast processes for the onboard processor of the CPS 404. The scheduler device 402 may schedule a medium, fast process for the low-power laptop 422. The scheduler device 402 may schedule a medium process for the high-power workstation 420. The scheduler device 402 may schedule a heavy, slow process for the cloud resource 424.

The scheduler device 402 may use the utility function 116 to distinguish between light (e.g., fast) versus heavy (e.g., slow) processes. In some examples, the utility function 116 may evaluate the latency to perform the process that would result for each computing resource. In some cases, processing latency may be less than or greater than transmission latency due to differences in processing power as compared with transmission distances. In other examples, the different processes (e.g., a light process, a medium process, a heavy process) may each have its own utility function 116 with different weights for the utility function factors. Because the different processes may have different utility functions 116, the scheduler device 402 may schedule different computing resources to perform the different processes.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
evaluating a plurality of computing resources to perform a process for a cyber-physical system (CPS) based on a utility function, a first computing resource being onboard the CPS and a second computing resource being a remote computing resource; and
scheduling a computing resource that optimizes the utility function to perform the process for the CPS.

2. The method of claim 1, wherein the utility function weights a plurality of factors to perform the process.

3. The method of claim 2, wherein the plurality of factors of the utility function comprises latency, cost, energy consumption and CPS stability to perform the process.

4. The method of claim 3, wherein the latency evaluated by the utility function comprises a time for the process to be executed on a computing resource and for the results to be available for the CPS.

5. The method of claim 3, wherein the cost evaluated by the utility function comprises a computed amount to be paid to a provider of a computing resource to perform the process on the computing resource.

6. The method of claim 3, wherein the energy consumption evaluated by the utility function comprises an estimated amount of energy to perform the process on the computing resource.

7. The method of claim 3, wherein the CPS stability evaluated by the utility function comprises maintaining the CPS at an equilibrium point.

8. A scheduler device, comprising:
a memory;
a processor coupled to the memory, wherein the processor is to:
determine a process to be performed for a cyber-physical system (CPS);
calculate a utility function value to perform the process by a computing resource onboard the CPS;
calculate a utility function value to perform the process by a remote computing resource; and
schedule a computing resource that maximizes the utility function to perform the process.

9. The scheduler device of claim 8, wherein the remote computing resource comprises an edge computing device.

10. The scheduler device of claim 8, wherein the remote computing resource comprises a cloud computing resource.

11. A method, comprising:
calculating a utility function value for each of a plurality of computing resources to perform a process for a cyber-physical system (CPS), a first computing resource being onboard the CPS and a second computing resource being a remote computing resource;
storing the utility function value for each of the plurality of computing resources in a buffer;
determining a computing resource that maximizes the utility function; and
scheduling the process on the computing resource that maximizes the utility function.

12. The method of claim 11, further comprising selecting a utility function to evaluate the plurality of computing resources to perform the process.

13. The method of claim 11, wherein the utility function comprises a plurality of factors with weights assigned to each of the plurality of factors based on capability of the CPS and a use case of the process.

14. The method of claim 11, further comprising calculating a utility function value to perform the process for each of a plurality of remote computing resources.

15. The method of claim 11, further comprising scheduling a plurality of processes to be performed for the CPS from among the plurality of computing resources based on a utility function associated with each of the plurality of processes.
